(19) United States
(12) Patent Application Publication
(10) Pub. No.: US 2003/0214411 A1
(43) Pub. Date: Nov. 20, 2003

(54) Apparatus and method for use of a radio locator, tracker and proximity alarm

(76) Inventors: Ronald Jeffrey Walter, Anaheim, CA (US); Robert A. Bell, Encinitas, CA (US); Taylor Gahr, San Diego, CA (US); Gary Bann, San Diego, CA (US)

Correspondence Address: Daniel L. Dawes, Myers Dawes Andras & Sherman LLP, Suite 1150, 19900 MacArthur Blvd., Irvine, CA, 92612, US

(21) Appl. No.: 10/396,910

(22) Filed: Mar. 25, 2003

Related U.S. Application Data
(60) Provisional application No. 60/367,468, filed on Mar. 26, 2002.

(51) Int. Cl. G08B 23/00

(52) U.S. Cl. 340/573.4; 340/539.11

(57) ABSTRACT

A system comprised of a parent and child unit perform multiple position-dependent functions. The parent and child unit each comprises a directional antenna, power source, transceiver, processor and memory. The processor is coupled to the transceiver to control transmission and reception in each unit according to a predetermined stored protocol. The parent unit has a directional antenna and the child unit has an omnidirectional antenna. The transceivers in the units bidirectionally communicate to automatically perform one or more of the multiple position-dependent functions including electronic leash, finder, and proximity functions. Typically, a plurality of child units bidirectionally communicate with the parent unit to automatically perform the multiple position-dependent functions over a plurality of frequencies, by means of a plurality of different digital codes or both. The invention also comprises a method comprised of the steps necessary for performing the functions.

### RELATED APPLICATIONS

The present application is related to U.S. Provisional Patent Application serial No. 60/367,468, filed on Mar. 26, 2002, which is incorporated herein by reference and to which priority is claimed pursuant to 35 USC 119.

### BACKGROUND OF THE INVENTION

1. Field of the Invention

The invention relates to the field of tracking, locating and proximity alarm systems and methodologies, and more particularly to a personal tracking, locating and alarm system and method.

2. Description of the Prior Art

Child, pet or object monitoring systems are well known and one example is described in Olmassakian U.S. Pat. No. 5,900,817 (1999). Olmassakian is directed to a monitoring system for indicating to an adult, when a monitored child has moved beyond a safe predefined maximum distance limit. The monitoring system includes a first electronic module suitably fixed to the monitored individual and arranged to exchange signals that are useful to determine the relative distance and direction the first electronic module is from a suitable second electronic module. The second electronic module, which is in the possession of the adult, is arranged to exchange signal information with the first electronic module and indicate information including the distance between and the direction of the child. Should the distance between the monitored and supervisory individuals increase beyond the maximum distance limit, an alarm is sounded. The second electronic module includes a direction display and distance display, that may be employed by the adult to locate the monitored child.

Elliot U.S. Pat. No. 6,243,039 (2001) is directed to an anytime/anywhere child locator system that tracks the current and historical locations of a GPS locator device carried by a parent to monitor the location of a child. Monitoring of a child's location may be conducted via a Web site, which provides graphical maps of location data, or via calling into a call center. A means is provided for a parent to trigger the automatic transmission of the device's location, via a Web site or call placed to a call center agent or a VRU. A process of auto-notification of a device's movement that exceeds a pre-specified threshold is provided and also includes a capability to function as a proximity alert device.

Haner, U.S. Pat. No. 6,396,403 discloses a child monitoring system which includes a combination bracelet and camera transmitting assembly, and a receiver for tracking and providing audible and visual contact with a child or object within a predetermined area or domain. The bracelet transmitting assembly is releasably attached to the wrist or ankle of a child, and transmits signals for detection by a remote hand-held or belt worn monitor. The camera transmitting assembly is also attached to a user via a clothing article such as a button or pocket to obtain and transmit video signals to the monitor. For longer distance monitoring, GPS microminiaturized technology may be employed. The bracelet transmitting assembly includes a locking mechanism and circuitry for two way-speaker communication or monitoring. A plastic sleeve is also provided for the bracelet as a protective covering. The receiver includes a GPS switch, activated to display the latitude-longitude coordinates of the child, who wears a GPS receiver/transmitter and antenna.

Neyhart, U.S. Pat. No. 5,939,988 (1999) discloses a child monitoring system that includes a first unit that is worn or is otherwise attached to a child, and a monitoring unit intended to be possessed by a parent or guardian responsible for the child. The monitoring system serves to monitor the proximity of the child to the monitoring unit, and provides for alarms at the child's and monitoring units that warn the guardian and those near the child that the child has moved beyond a preset distance from the monitoring unit.

Lopes, U.S. Pat. No. 6,169,494 (2001) shows a biotelemetry tracking and locating system which uses a person's own physical or biological measurement as an identification code used by a tracked unit, e.g., a bracelet worn by a child, to track and/or locate the person from a tracking/locating unit, e.g., worn or carried by a parent. The tracking/locating unit includes a transmitter and optionally a receiver. The tracking/locating unit detects a combination of encoded biological measurements (e.g. body temperature, and/or heart rate) and combines the biological measurements into a substantially unique ID code. The tracking/locating unit may be carried, e.g., by a parent to track the continued presence within a reception range of, e.g., a child wearing the tracked unit. A directional antenna, e.g., a YAGI type antenna, in the tracking/locating unit allows the tracking/locating unit to determine which direction the tracked unit is in, e.g., with respect to the tracking/locating unit. A panic button can be included with the tracked unit to allow a child or other person wearing a tracked unit to alert the tracking person, e.g., a parent to a dangerous situation. The tracking unit may include a paging button to output a paging signal to desired tracked units, which is emitted visually or aurally at the tracked unit.

Welch U.S. Pat. No. 6,075,442 (2000) is directed to a low power child locator system which consists of a lightweight, low power radio frequency transmitter beacon worn by the child and a radio frequency directional receiver that can be used to direct the user to the radio frequency beacon transmitter. The transmitter can be programmed to generate a unique signal to prevent its output radio signal from being received by another receiver. The transmitter-receiver pair therefore communicates to the exclusion of other transmitters and receivers that are operational in the vicinity of the transmitter-receiver pair. Since the child is assumed to not have traveled a great distance from their original location, the radio frequency directional receiver operates as a simple signal strength indicator, using a plurality of narrow beam antennas to enable the user to vector in on the transmitted signal. Each of the plurality of directional antennas is capable of receiving radio signals of predetermined characteristics exclusively from a narrowly defined region of space which is located proximate to the ground and radially extending outward from the directional antenna. A plurality of indicators, each associated with at least one of the plurality of directional antennas and capable of a variable range of illumination magnitude are used in conjunction with a signal strength detector. The signal strength detector activates the plurality of indicators as a function of the identified strength of the radio signals received from each of the associated plurality of directional antennas to thereby indicate the direction from which the radio signals emanate.

Rabanne, et al. U.S. Pat. No. 6,304,186 (2001) describes a system for selectively detecting the presence of a plurality of objects in proximity to a person. The system includes a plurality of child units each having a first communicating device (such as a transceiver) for sending a locator signal and for receiving a control signal. Further, the system includes a parent unit having a second communicating device for receiving the locator signal from at least one of the plurality of child units, a processor for monitoring the at least one child unit and for determining whether the child unit is within a preselected range, at least one alarm for signaling the person when the selected child unit is outside the preselected range, and controls for selectively controlling the child units to be monitored and for controlling activation of the child units.

Musa U.S. Pat. No. 5,557,259 (1996) discloses a proximity alert and direction indicator is provided that allows an observer to monitor the proximity of a subject under surveillance, particularly a child. The subject wears a transmitter removably attached to the shoe. The observer wears a receiver-containing bracelet. The receiver contains a proximity detector with threshold set that emits an audible sound when the distance between the subject and the observer exceeds some preset distance. The receiver also contains a direction finder with graphic display that shows the observer the direction to the subject.

Friedman, U.S. Pat. No. 5,337,041 (1994) is a personal safety guard system enables a guardian or caretaker of a person or pet to transmit an alarm condition signal from a hand-held unit carried by the guardian. When the alarm condition signal is received by a portable alarm unit adapted to be worn by the person or pet under the guardian's supervision, the alarm unit operates to alert the wearer that its guardian is looking for them, and to alert others nearby that the wearer is in need of assistance by producing a number of different alarm indicators. The alarm indicators produced by the portable alarm unit include an intelligible voice message such as “Help, I'm lost” which is alternately sounded with a loud alarm sound, and flashing strobe lights. These alarm indicators, together with a confirmation signal transmitted from the alarm unit to the guardian's unit, enable the guardian to track and find their charge.

Cox, U.S. Pat. No. 4,598,272 (1986) describes an electronic monitoring apparatus that not only enables the monitoring person to monitor the whereabouts of the monitored person, pet or article, but also to locate the latter if he, she or it becomes separated from the monitoring person. It also enables the monitoring person to interrupt an abductor, to draw attention to him, to frighten or confuse him, and hopefully, to cause him to release the monitored person, pet or article.

Azizi, et al. U.S. Pat. No. 5,525,967 (1996) describes a system and method for tracking and locating an object by employing elements that enable the user to pinpoint both the distance and the direction of the person or object being monitored relative to the position of the monitoring or transmission unit (the “source”), comprising a tracking transceiver unit, which tracks and monitors the person or object, and the target transceiver unit, which is worn or affixed to the person or object being monitored. The tracking transceiver unit broadcasts a signal to a target transceiver unit, which, upon receiving the signal, will then broadcast a response signal back to the tracking transceiver unit. The tracking transceiver unit's antenna, which comprises a plurality of flat sensor plate-like elements formed together in a generally spherical configuration, picks up the signal and then conveys the information it receives to a special response signal processor unit, which analyzes the data to determine the direction of the person or object being monitored. Information filtered and analyzed through the response signal processor unit is then conveyed to a central processor unit, which uses the data to calculate the distance of the person or object being monitored from the source.

Clearly people, patients (Alzheimer's patients), pets and other objects can get lost and need to be found. A simple method is needed to provide the ability for the responsible party to determine the relative location (direction and range) of the object from him/herself, thus ‘locating’ the object. If the object is moving, then a constant update of the relative position is needed to ‘track’ said object. The ability of tracking and locating is extremely important for people or other objects, which might be in danger from abduction, kidnapping, in need of medical assistance or valuable to the owner. A tracking system should be light-weight and portable, i.e. both the tracked object unit and the finder/tracker unit.

### BRIEF SUMMARY OF THE INVENTION

The invention is a system for performing multiple position-dependent functions comprising a parent unit and a child unit. The parent unit comprises a directional antenna, a first power source, a first transceiver, a first processor and a first memory. The first power source is coupled to and provides power to the first transceiver, first processor and first memory. The first memory and first processor are coupled together to form a firmware controlled first circuit combination. The first processor is coupled to the first transceiver to control transmission and reception by the first transceiver according to a predetermined first protocol stored within the first memory. The directional antenna is coupled to the first transceiver.

The child unit comprises an omnidirectional antenna, a second power source, a second transceiver, a second processor and a second memory. The second power source is coupled to and provides power to the second transceiver, second processor and second memory. The second memory and second processor are coupled together to form a firmware controlled second circuit combination. The second processor is coupled to the second transceiver to control transmission and reception by the second transceiver according to a second predetermined protocol stored within the second memory. The omnidirectional antenna is coupled to the second transceiver.

The first and second transceivers bidirectionally communicate with each according to a common portion of the first and second predetermined protocols to automatically perform one or more of the multiple position-dependent functions.

In the illustrated embodiment the directional antenna is a single antenna. The first and second predetermined protocols place the parent and child units periodically in a sleep or low power consumption mode of operation and periodically in a full power consumption mode to conserve battery life as well as minimize potential radio interference or traffic.

In the illustrated embodiment the system further comprises a plurality of child units. The first transceiver in the parent unit and second transceivers in the child units bidirectionally communicate with each to automatically perform the multiple position-dependent functions over a plurality of frequencies, by means of a plurality of different digital codes or both.

The first transceiver in the parent unit and second transceivers in the child units bidirectionally communicate with each to automatically and simultaneously or contemporaneously perform the multiple position-dependent functions among the plurality of child units, including electronic leash, finder, and proximity functions. As defined in more detail in the specification below, the function “electronic leash” determines when the child unit exceeds a predetermined threshold distance away from the parent unit. The “proximity” function is the opposite to the electronic leash in that it determines when the child unit intrudes within a predetermined threshold distance to the parent unit. The “finder” function determines the direction and distance to the child unit from the parent unit. Direction is determined by the strength of signal as a function of orientation of the directional antenna in the parent unit. Distance can be determined by any method now known or later devised and in the simplest embodiment uses the 1/r² dependence of signal strength as a measuring means. A calibration step can be included with the child unit positioned first at a known distance from the parent unit. The parent unit generates a direction and distance indication with respect to the child unit. For example, the system can be used by firefighters in near zero visibility situations where the whereabouts of each firefighter needs to be monitored at all times.

The system includes the configuration where the plurality of child units are each programmable to operate to perform at least one of the electronic leash, finder, and proximity functions. In addition the first and second predetermined protocols include third party police/rescue protocols, i.e. communication with existing security, police, fire, auto theft prevention, search and rescue, ambulance and other protection services.

The invention also comprises a method comprised of the steps necessary for performing the functions attributed to the system above.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a simplified block diagram of the child unit.

FIG. 2 is a flowchart of the operation of the child unit.

FIG. 3 is a simplified block diagram of the parent unit.

FIG. 4 is a flowchart of the operation of the parent unit.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

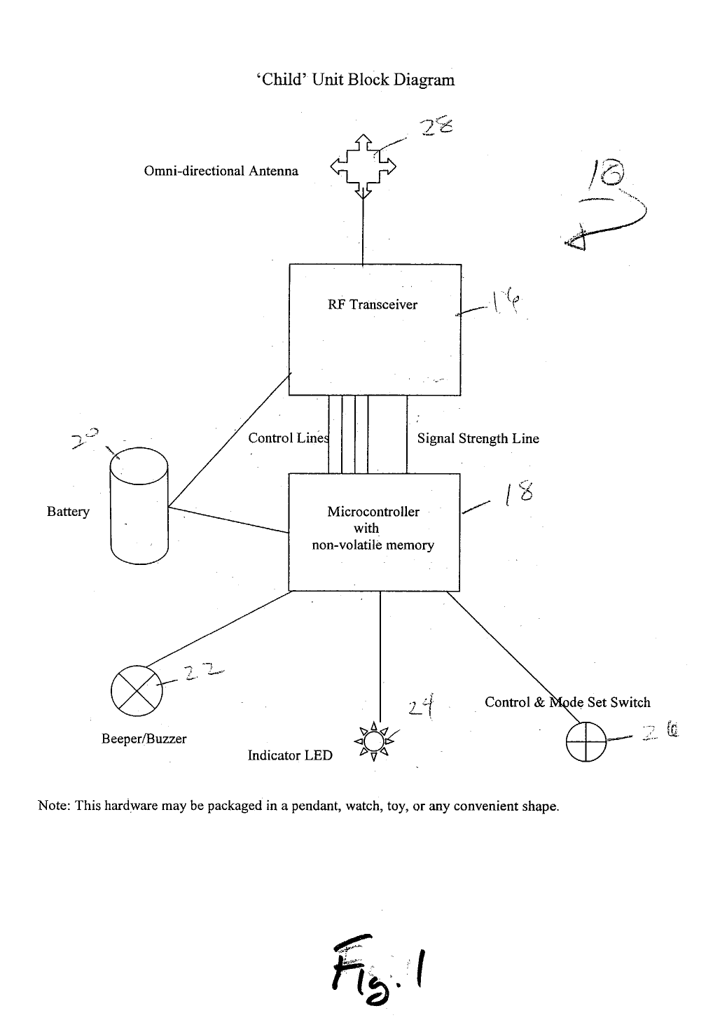

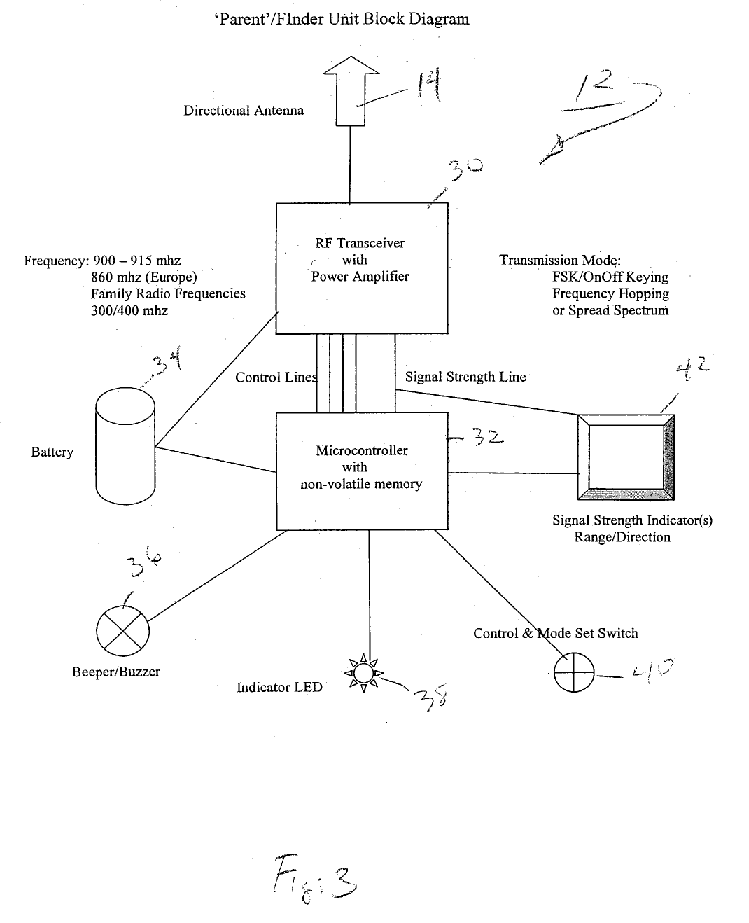

The invention is styled as a “Companion Radio Tracking/Locating System”. It is a system for tracking and/or locating an object using radio. A “child” unit, generally denoted by reference numeral 10 and diagrammatically depicted in the block diagram of FIG. 1, is attached to a child, adult, pet or other object that may need to be tracked or located. Child unit 10 is quiet or nontransmitting in the normal mode. A “parent” unit, generally denoted by reference numeral 12 and diagrammatically depicted in the block diagram of FIG. 3, can request via a uniquely identifying code and frequency combination that “child” unit 10 begin transmission. Using only a single directional antenna 14, the “parent” unit 12 will indicate to the operator the direction of the child unit 10 and also provide an indication of the distance from the operator of the “child” unit 10.

The Companion Radio Locator/Tracker is thus comprised of two separate units. A ‘child’ unit 10 as diagrammatically shown in FIG. 1 is comprised of a small, battery operated radio transceiver unit 16 which can be attached to clothing, a collar, belt or other part of the object to be located or tracked. One omnidirectional antenna 28 is coupled to transceiver unit 16. Transceiver unit 16 is coupled to a microcontroller with nonvolatile memory 18. Both are powered by battery 20. There may be an indicator, such as LED 24 to indicate that the unit is powered. There may also be an audio noise generator 22, which can be activated to indicate that the unit is being tracked or that an attempt is being made to locate the unit 10. Operation of child unit 10 may be manually set or controlled by a control and mode set switch 26 coupled to microcontroller and memory 18.

The second component is a ‘parent’ unit 12 is roughly the size of a cellular phone, and also contains a radio transceiver 30 as diagrammatically depicted in FIG. 3. As with child unit 10, parent unit 12 includes a microcontroller with nonvolatile memory 32 coupled to transceiver 30 with both powered by battery 34. An audio beeper or buzzer 36 provides audio output and is coupled to microcontroller and memory 32. In addition there are lights or LED 38 and an indicator 42, such as a panel meter, which are used to indicate the direction and range of the child unit 10. Operation of parent unit 12 may be manually set or controlled by a control and mode set switch 40 coupled to microcontroller and memory 32.

It must be understood that the number and nature of the input and output devices employed with or by units 10 and 12 is also quite general and may include any other or additional numbers and types of input and output devices now known or later devised.

Both units 10 and 12 are quiet or nontransmitting in their normal mode. The ‘child’ unit 10 listens periodically for a signal from the ‘parent’ unit. This conserves battery life. Each ‘child’ unit 10 is identified by a unique combination of RF Frequency, transmission type (FSK shift) and transmitted code. Any type of communication protocol may be employed in addition to frequency shift keying, FSK, such as on/off keying, frequency hopping, spread spectrum or any other protocol now known or later devised. The choice of frequencies is also arbitrary and will be dictated largely by the regional control authority where the system is employed, such as the FCC in the case of the United States. These are chosen to uniquely identify the unit 10 and also to permit several ‘tracking or locating’ operations to occur simultaneously from different Companion systems.

The operator of the ‘parent’ unit 12 desiring to track or locate the ‘child’ unit will activate the locating operation by pressing a button or switch. This will cause the ‘parent’ unit 12 to alternatively transmit the ‘child’ unit's 10 unique identifier and listen for a response. During this process the user is moving the ‘parent’ device to point at all quadrants around him or herself.

The ‘child’ unit 10 upon detecting its unique code will begin to transmit continuously for a limited period of time (2-3 minutes) to conserve battery life. The single directional antenna 14 of the ‘parent’ unit 12 will pick up the return signal and indicate to the operator that the ‘child’ unit 10 has been detected from the direction pointed at by directional antenna 14. Another indicator will indicate the relative distance to the ‘child’ unit 10.

The initial locating signal from the ‘parent’ unit 12 may indicate that the ‘child’ unit 10 should or should not activate its audio alarm. This will be determined by the operator. An audio signal may help in locating the ‘child’ unit 10 when in close proximity.

When the locating/tracking operation has been concluded, both units 10 and 12 are again quiet or nontransmitting. A ‘parent’ unit 12 may be configured to locate/track more than one ‘child’ unit 10. It would be able to activate a search for one of N different ‘child’ units 10 based upon it setup and configuration.

The Companion Radio Tracking/Locating system is small, battery operated and easy to carry. It uses but a single antenna 14 to operate the direction finding. The system also does not clutter the RF spectrum as the units 10 and 12 are quiet except when finding or tracking. This also conserves battery life. The inclusion of audio signal capability provides more accurate close proximity locating.

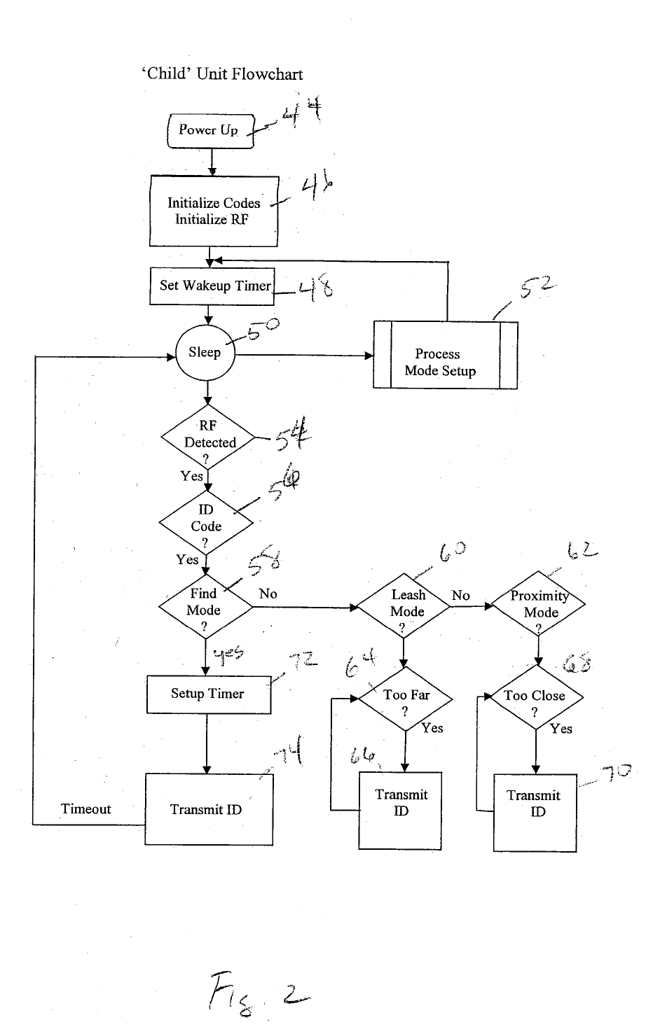

The general method of operation and use having now been described, consider the detailed operation of each unit 10 and 12 more closely. FIG. 2 is a flowchart summarizing the operation of one embodiment of child unit 10. Operation of child unit 10 begins with the power-up step at 44. Its identification codes, which are stored nonvolatilely in memory 18 are read and transceiver 16 is initialized at step 46. A wakeup timer is then set at step 48, which will turn on unit 10 periodically to determine if it is being sought by a parent unit 12. Unit 10 then returns to a sleep mode at step 50. When the timer goes off in microprocessor 18, the mode setup is processed at step 52 and processing reinitiated by resetting the wakeup timer at step 48 and entering the sleep mode at step 50. If, however, an RF signal is detected when the sleep mode is first entered at step 54, a determination is made by microprocessor 18 whether the predetermined identification code of unit 10 is being polled at step 56.

In the illustrated embodiment, unit 10 automatically operates variously in a FIND, LEASH and PROXIMITY mode. A determination is made at step 58 if it is in the FIND mode. The FIND mode is the operational mode in which child unit 10 is being sought out by parent unit 12 and needs to respond to a search call. If unit 10 is in the FIND mode, it then setups a transmission timer at step 72 and begins transmitting its identification code at step 74. Transmission of the identification code continues for a preset time duration and then will timeout, shutting down unit 10 and returning it to the sleep mode at step 50.

If unit 10 is not in the FIND mode, it will then determine at step 60 whether it is in the LEASH mode. The LEASH mode is an operational mode wherein child unit 10 is to be keep within a predetermined distance of parent unit 12, i.e. keep on an electronic leash. If child unit 10 strays by more than a predetermined distance from parent unit 12, then microprocessor 18 will generate an audio signal in child unit 10 to notify the parent unit 12 that the permitted leash distance has been exceeded. The parent unit 12 may also generate an audio signal to alert the parent. The determination of distance is made at step 64 and if it is exceeded, the identification code is generated by child unit 10 at step 66.

If on the other hand unit 10 is set in the PROXIMITY mode, this determination is made at step 62. The PROXIMITY mode is the opposite of the LEASH mode and will notify the users when child unit 10 and parent unit 12 move to positions relative to each other closer than a predetermined perimeter or distance. Such an alarm may be needed for example when a pet is to remain outside of an area. Again the minimum distance is determined by microprocessor 18 at step 68 and, if alarmed, will transmit an appropriate code at step 70. Clearly, a different code can be transmitted depending on which mode unit 10 is in.

In both LEASH and PROXIMITY modes, the audio alert and signalling may continue as long as the range and limits of the specified modes remain violated that is, as long as the child unit 10 remains too far away from the parent unit 12 the audio alert will continue.

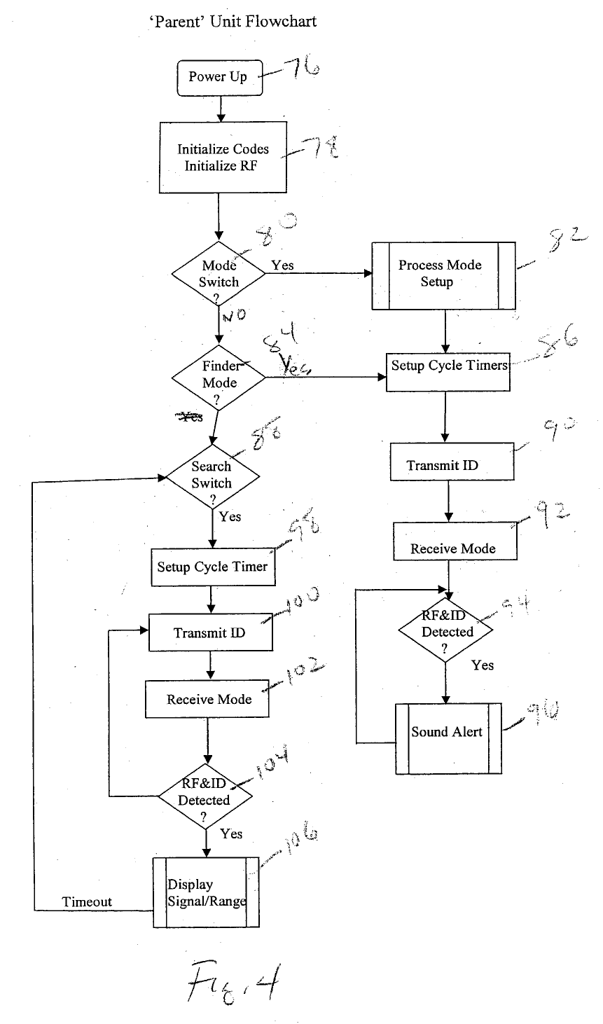

The operation of parent unit 12 is depicted by the flowchart of FIG. 4. Unit 12 operates in a FINDER mode and in a SEARCH mode. The FINDER mode seeks to determine if the leash or proximity limits of child unit 10 have been reached. The SEARCH mode seeks to determine the direction and distance of the child unit 10 from parent unit 12.

Power up occurs at step 76 and the codes used by unit 12 are initialized as is transceiver 30 at step 78. The mode switch 40 is interrogated at step 80 to determine is a particular mode of operation has been manually set. If so, the set mode is processed by microprocessor 32 at step 82 and the cycle timers in microprocessor 32 setup at step 86. A determination is then made at step 84 whether the FINDER mode is set. If it has, then the cycle timers are setup at step 86 and the identification code of the desired child unit 10 is transmitted according to the predetermined timing at step 90. Unit 12 then waits for an answer back from unit 10 at step 92. If an answering RF signal and identification code is recognized at step 94, the a leash or proximity alarm is sounded in unit 12 at step 96.

On the other hand if it is determined at step 88 that the SEARCH mode is set, a corresponding set of cycle timers in microprocessor 32 is setup at step 98, and the desire identification code transmitted at step 100. Again microprocessor 32 controls transceiver 30 at step 102 to listen for an answerback signal. If at step 104 the RF signal and code is recognized, then the resulting signal indication of a “find” is generated and the distance of unit 10 computed at step 106. The process continues according to the protocol set up in the cycle timers until a timeout signal is received and unit 12 is then returned to step 88 to determine if a SEARCH is still required.

The illustrated embodiment has been described in terms of a portable unit 12 and portable unit 10 within the transmission range of their transceivers, however, it must be understood that either unit 10 or 12 may be arranged and configured to operate in combination with a network. For example, unit 10 and 12 may communicate with each other through a radio, computer or cellular network over extended distances equal to the coverage provided by the network. Depending on the nature of the network, of course, directional and distance information obtainable may be modified or lost, but identification and tracking may still occur, for example by identifying the cell in which the lost person or object is located.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A system for performing multiple position-dependent functions comprising:
a parent unit comprising a directional antenna, a first power source, a first transceiver, a first processor and a first memory, the first power source coupled to and providing power to the first transceiver, first processor and first memory, the first memory and first processor coupled together to form a firmware controlled first circuit combination, the first processor coupled to the first transceiver to control transmission and reception by the first transceiver according to a predetermined first protocol stored within the first memory, the directional antenna coupled to the first transceiver; and
a child unit comprising an omnidirectional antenna, a second power source, a second transceiver, a second processor and a second memory, the second power source coupled to and providing power to the second transceiver, second processor and second memory, the second memory and second processor coupled together to form a firmware controlled second circuit combination, the second processor coupled to the second transceiver to control transmission and reception by the second transceiver according to a second predetermined protocol stored within the second memory, the omnidirectional antenna coupled to the second transceiver;
wherein the first and second transceivers bidirectionally communicate with each according to a common portion of the first and second predetermined protocols to automatically perform the multiple position-dependent functions.

2. The system of claim 1 where the directional antenna is a single antenna.

3. The system of claim 1 where the first and second predetermined protocols place the parent and child units periodically in a sleep or low power consumption mode of operation and periodically in a full power consumption mode.

4. The system of claim 1 further comprising a plurality of child units and wherein the first transceiver in the parent unit and second transceivers in the child units bidirectionally communicate with each to automatically perform the multiple position-dependent functions over a plurality of frequencies.

5. The system of claim 1 further comprising a plurality of child units and wherein the first transceiver in the parent unit and second transceivers in the child units bidirectionally communicate with each to automatically perform the multiple position-dependent functions by means of a plurality of different digital codes.

6. The system of claim 1 further comprising a plurality of child units and wherein the first transceiver in the parent unit and second transceivers in the child units bidirectionally communicate with each to automatically perform the multiple position-dependent functions over a plurality of frequencies and by means of a plurality of different digital codes.

7. The system of claim 1 further comprising a plurality of child units and wherein the first transceiver in the parent unit and second transceivers in the child units bidirectionally communicate with each to automatically and simultaneously perform the multiple position-dependent functions among the plurality of child units, including electronic leash, finder, and proximity functions.

8. The system of claim 7 where the plurality of child units are each programmable to operate to perform at least one of the electronic leash, finder, and proximity functions.

9. The system of claim 1 wherein the first and second predetermined protocols include third party police/rescue protocols.

10. The system of claim 1 where the parent unit generates a direction and distance indication with respect to the child unit with an audio alert dependant on distance.

11. A method for performing multiple position-dependent functions comprising:
transceiving a radio frequency signal from a parent unit using a directional antenna controlled by a first processor according to a predetermined first protocol stored within a first memory coupled to the first processor; and
transceiving a radio frequency signal from a child unit using an omnidirectional antenna controlled by a second processor according to a predetermined second protocol stored within a second memory coupled to the second processor;
wherein the parent and child units bidirectionally communicate with each according to a common portion of the first and second predetermined protocols to automatically perform the multiple position-dependent functions.

12. The method of claim 11 where transceiving radio frequency signals through the parent unit is performed through a single antenna.

13. The method of claim 11 further comprising operating the parent and child units periodically in a sleep or low power consumption mode of operation and periodically in a full power consumption mode.

14. The method of claim 11 where a plurality of child units are provided and where transceiving a radio frequency signal from a parent unit and each child unit comprises bidirectionally communicating with each child unit to automatically perform the multiple position-dependent functions over a plurality of frequencies.

15. The method of claim 11 where a plurality of child units are provided and where transceiving a radio frequency signal from a parent unit and each child unit comprises bidirectionally communicating with each child unit to automatically perform the multiple position-dependent functions by means of a plurality of different digital codes.

16. The method of claim 11 where a plurality of child units are provided and where transceiving a radio frequency signal from a parent unit and each child unit comprises bidirectionally communicating with each child unit to automatically perform the multiple position-dependent functions over a plurality of frequencies and by means of a plurality of different digital codes.

17. The method of claim 11 where a plurality of child units are provided and where transceiving a radio frequency signal from a parent unit and each child unit comprises bidirectionally communicating with each child unit to automatically perform the multiple position-dependent functions among the plurality of child units, including electronic leash, finder, and proximity functions.

18. The method of claim 17 further comprising programming each of the plurality of child units to operate to perform at least one of the electronic leash, finder, and proximity functions.

19. The method of claim 11 where transceiving a radio frequency signal from a parent unit and each child unit comprises bidirectionally communicating according to the first and second predetermined protocols include third party police/rescue protocols.

20. The method of claim 11 where transceiving a radio frequency signal from a parent unit and each child unit comprises generating a direction and distance indication in the parent unit with respect to the child unit.
